(19) United States
(12) Patent Application Publication
(10) Pub. No.: US 2007/0055819 A1
(43) Pub. Date: Mar. 8, 2007

(54) Information recording medium and its control method

(76) Inventors: Hirokazu So, Osaka (JP); Masato Suto, Osaka (JP); Shinji Inoue, Osaka (JP); Takuji Maeda, Osaka (JP); Kazuya Fujimura, Nara (JP); Yukiko Inoue, Osaka (JP); Makoto Ochi, Osaka (JP)

Correspondence Address: GREENBLUM & BERNSTEIN, P.L.C., 1950 ROLAND CLARKE PLACE, RESTON, VA, 20191, US

(21) Appl. No.: 10/578,373

(22) PCT Filed: Nov. 1, 2004
(86) PCT No.: PCT/JP04/16225

§ 371 Date: Aug. 7, 2006

(30) Foreign Application Priority Data
Nov. 7, 2003 (JP) 2003-378267

(51) Int. Cl. G06F 12/00

(52) U.S. Cl. 711/112

(57) ABSTRACT

An information recording medium (100) is a recording medium to/from which data can be written/read from a data processing apparatus. The recording medium includes a host interface (110) for communicating with the data processing apparatus, a data storage section (130) having a plurality of recording regions (#1, . . . ,#N) for storing data, and a region information storage section (124) for storing information on each recording region. The region information storage section (124) stores information about address attribute of each recording region of the data storage section (130). The information about the address attribute includes information indicating unit (byte or sector) of address specified on access to the recording region.

### TECHNICAL FIELD

The present invention relates to an information recording medium having plural recording regions, and a control method of such recording medium.

### BACKGROUND ART

Recording media for recording digital data (or data hereinafter) such as music contents, movie contents and still picture contents include various types such as semiconductor recording medium, magnetic disk, optical disk, and magneto-optical disk. In particular, the semiconductor recording medium can be reduced in size and weight, and is rapidly and widely spreading in the field of portable devices such as digital still camera and portable telephone terminal. Representative examples of semiconductor recording medium include SD Memory Card (registered trademark), Memory Stick (registered trademark), and Compact Flash (registered trademark).

Management of data stored in recording regions of these recording media is realized by a file system. In the file system, the recording region is managed with divided sectors as minimum access unit and divided clusters as sets of sectors, and one or more clusters are managed as file.

One of the conventional file systems is FAT (File Allocation Table) file system (for detail, see non-patent document 1). The FAT file system is generally used in information apparatuses such as a personal computer (PC), and is a representative file system also in a semiconductor recording medium. For recording media having the data managed by the file system, since the file can be shared between devices interpreting the same file system, data can be exchanged between devices.

The FAT file system can manage the data only to the maximum capacity of 2 GB, and it is needed to employ a file system other than the FAT file system in the field of semiconductor recording medium which increase in capacity year after year. File systems capable of handling large capacity other than FAT file system include FAT32 file system and UDF (Universal Disk Format).

However, when the file system of the recording medium is changed to other than the FAT file system, the device conforming to the conventional FAT file system cannot access the data in the new recording medium.

To solve the problem, hitherto, it has been proposed to provide the recording medium with regions for storing plural pieces of file system management information, and regions for storing common file data (see, for example, patent document 1).

Patent document 1: JP-A-8-272541.

Non-patent document 1: ISO/IEC9232, Information Technology—Volume and file structure of disk cartridges for information, 1994.

### DISCLOSURE OF THE INVENTION

(Problems to be Solved by the Invention)

In the above control method, however, to update one file data, it is required to update plural pieces of file system management information at the same time, and the device conforming to one file system only cannot update management information of file systems the device does not conformed to, and hence file data cannot be updated. Accordingly, it may be considered to provide the recording medium with plural recording regions, and manage the data by independent file systems in individual recording regions. According to this method, even in the device conforming to one file system only, the file data can be updated in the recording regions in which data is managed by a file system which can be interpreted by this device.

On the other hand, the address specified in the conventional access command is specified in units of bytes. Accordingly, when the address space of the recording medium is expanded as a result of an increase in recording capacity, the bit width of address region in the command format is insufficient, and the address cannot be expressed appropriately, and a wide address space cannot be accessed.

In the light of the problems discussed above, it is an object of the invention to present a recording medium applicable to plural file systems by changing over plural recording regions, and more particularly a recording medium capable of specifying an address in a wide address space and a control method of such recording medium.

(Solving Means)

A recording medium according to the invention is a recording medium to/from which data can be written/read by a data processing apparatus. The recording medium includes a host interface operable to communicate with the data processing apparatus, a data storage section having plural recording regions for storing data, and a region information storage section for storing information about each recording region of the data storage section. The region information storage section stores information about address attribute of each recording region of the data storage section.

The address attribute may be a unit of address specified from the data processing apparatus for access to the recording region of the recording medium. For example, the unit of address is sector or byte.

The recording medium may further include a controller. The controller may receive a command for instructing writing or reading of data from the data processing apparatus by way of the host interface, and when the received command specifies an address indicating the access region, judge unit of the address specified by the received command, on the basis of the address attribute stored in the region information storage section.

Data stored in each recording region may be managed by the file system corresponding to each recording region.

The region information storage section may further store information about type of command set of the command received in the host interface. The region information storage section may further store information about type of format of the command received in the host interface.

The recording medium may further include a controller. The controller may receive from the data processing apparatus by way of the host interface, a command for setting an accessible recording region in the data storage section from the data processing apparatus. When the received command specifies the address attribute of the recording region set to be accessible, the controller may set an accessible region in the region information storage section according to the received command, and change the address attribute of the accessible region set.

The recording medium may further include a controller. When receiving a command for changing size of recording region in the data storage section through the host interface from the data processing apparatus, the controller may change size of recording region according to the received command, determine the address attribute of the changed recording region according to the changed size of the recording region, and update the region information storage section using the determined address attribute.

A control method according to the invention is a method of controlling a recording medium having a data storage region for storing data. The data storage region is accessible from outside for writing and reading data. The control method includes dividing the data storage region of the recording medium into plural recording regions, and storing region information which is information about each divided recording region to a predetermined region in the recording medium. The region information includes information about address attribute of each recording region.

(Effects of the Invention)

According to the invention, in a recording medium having plural recording regions, address attribute showing address specifying method in each recording medium is managed in each recording region. As a result, the unit of address specified in an access command can be recognized, and when specifying a wide address space, the address is specified by a data unit of large data size, or otherwise the address can be specified by a data unit of small data size. Hence, without changing the bit width for specifying the address in the format of an access command, a wide address space can be specified. That is, according to the invention, the command format conforming to the conventional file system for managing narrow address space can be directly applied in the file system for managing a wide address space.

### BRIEF DESCRIPTION OF THE DRAWINGS

FIG. 1 is a block diagram of recording medium and data processing apparatus of the invention.

FIG. 2 is a block diagram of data processing apparatus.

FIG. 3 is a diagram of an example of information stored in region information storage section of recording medium.

FIGS. 4A to 4C are diagrams of examples of command format corresponding to recording medium.

FIG. 5 is a flowchart of initialization process of recording medium.

FIG. 6 is a diagram of an example of region information storage section after initialization process.

FIG. 7 is a flowchart of initialization process and subsequent processes in data processing apparatus.

FIG. 8 is a flowchart of recording region changeover process in recording medium.

FIG. 9 is a diagram of an example of region information storage section after recording region changeover process.

FIG. 10 is a flowchart of recording region changeover process and subsequent processes in data processing apparatus.

FIG. 11 is a flowchart of other example of recording region changeover process in recording medium.

FIG. 12 is a diagram of an example of command data for changing over recording region.

FIG. 13 is a flowchart of data reading process in recording medium.

FIG. 14 is a flowchart of data reading process in data processing apparatus.

FIG. 15 is an explanatory diagram of relation between data range specified in units of bytes, and data range converted to units of sectors.

FIG. 16A is a flowchart of data writing process in data processing apparatus.

FIG. 16B is a flowchart of data writing process in data processing apparatus (continued from FIG. 16A).

FIG. 17 is an explanatory diagram of relation between data range in units of sectors being readout from recording medium, and data range in units of bytes specified from application.

FIG. 18 is a flowchart of region size setting process in recording medium.

FIG. 19 is a diagram of an example of command data for changing over region size.

FIG. 20 is a flowchart of region deletion process in recording medium.

FIG. 21 is a diagram of an example of command data for deleting a region.

FIG. 22 is a diagram of region information storage section for storing command set number and command format number.

FIG. 23 is a diagram of recording medium having physical switch for changing over effective recording regions.

### REFERENCE NUMERALS

100 Recording medium
110 Host interface
120 Controller
121 Command processing section
122 Access region judging section
123 Address determining section
124 Region information storage section
125 Recording region access section
130 Data storage section
200 Data processing apparatus
210 Recording medium loading section
220 Input and output processing section
230 Data processing section

### BEST MODE FOR CARRYING OUT THE INVENTION

Referring now to the accompanying drawings, preferred embodiments of information recording medium of the invention and its control method are specifically described below.

1. Configuration of Recording Medium and Data Processing Apparatus

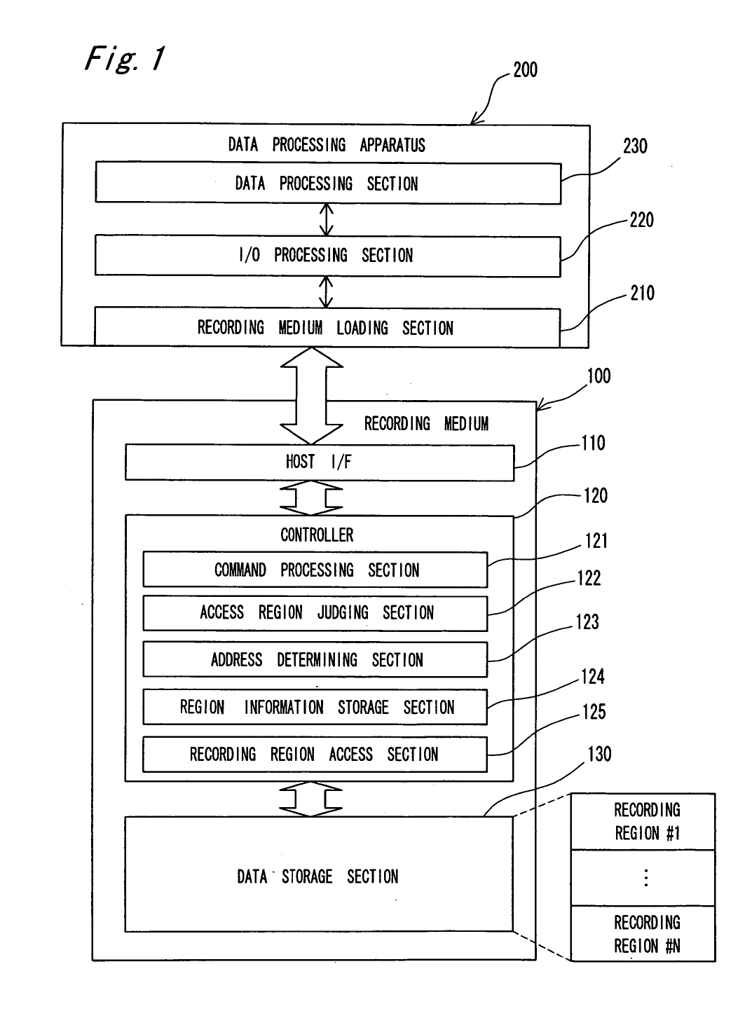

FIG. 1 shows configuration of a recording medium and a data processing apparatus in an embodiment of the invention. A recording medium 100 is composed of a host interface 110, a controller 120, and a data storage section 130.

The host interface 110 exchanges information with a data processing apparatus 200 which is a host device for the recording medium 100.

The data storage section 130 is means for storing data, and has regions capable of reading and writing of data by the data processing apparatus 200. The data storage section 130 includes N (N being an integer of 2 or more) recording regions #1, #2, . . . , #N. Data stored in each recording region is managed as file by a file system corresponding to each recording region.

The controller 120 controls the operation of the recording medium 100, and includes a command processing section 121, an access region judging section 122, an address determining section 123, a region information storage section 124, and a recording region access section 125.

The command processing section 121 interprets and executes the command from the data processing apparatus 200 received in the host interface 110, and informs the data processing apparatus 200 of the result, as required, by way of the host interface 110.

The access region judging section 122, in response to an access request from the command processing section 121, determines one recording region to be accessed from plural recording regions in the data storage section 130 based on the information stored in the region information storage section 124.

The address determining section 123 determines the address to be accessed with reference to the information stored in the region information storage section 124, for one recording region determined in the access region judging section 122.

The region information storage section 124 stores start address and region size of each recording region and parameters for determining the address or the like in the data storage section 130.

The recording region access section 125 accesses the data stored in the data storage section 130 based on the information determined by the access region judging section 122 and address determining section 123.

As mentioned above, the recording medium 100 has plural recording regions #1, #2, . . . , #N, and data managed in recording regions #1, #2, . . . , #N are managed by file systems corresponding to recording regions. One region is selected out of the plural recording regions of the recording medium 100, and data access by the data processing apparatus 200 is enabled to the selected recording region. Hereinafter, such recording region accessible by the data processing apparatus 200 is called an “effective recording region.”

The data processing apparatus 200 has a recording medium loading section 210, an input and output processing section 220, and a data processing section 230.

The recording medium loading section 210 is hardware for loading the recording medium 100.

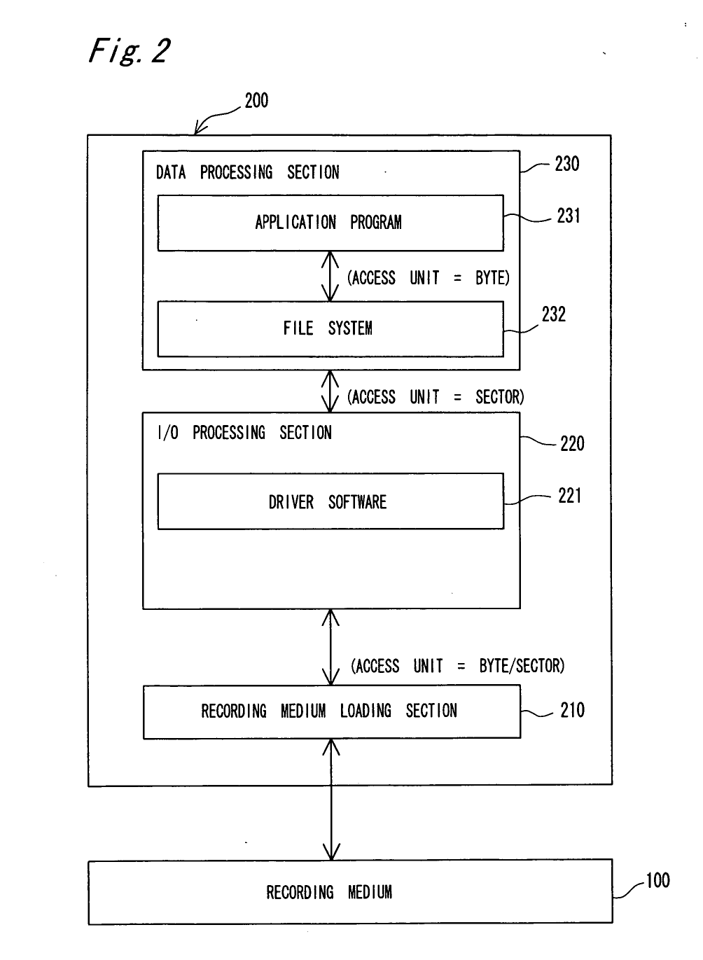

The input and output processing section 220 exchanges information such as command and data with the recording medium 100 loaded in the recording medium loading section 210. The input and output processing section 220 includes a driver software 221 for realizing the function of the input and output processing section 220 as shown in FIG. 2.

The data processing section 230 is means for processing data stored or data to be stored in the recording medium 100, and this means plays a central role in processing in the data processing apparatus 200. The function of the data processing section 230 is realized by an application program 231 and a file system 232. The application program 231 is a program for reproducing audio data or video data, and requests data access to the file system 232.

The access unit of data exchanged inside the data processing section 230 is explained. Between the application program 231 and file system 232, data is accessed in units of bytes. Between the data processing section 230 and input and output processing section 220, data is accessed in units of sectors. The driver software 221 of the input and output processing section 220 accesses the recording medium 100 in units of bytes or sectors depending on the address attribute of the effective recording region in the recording medium 100.

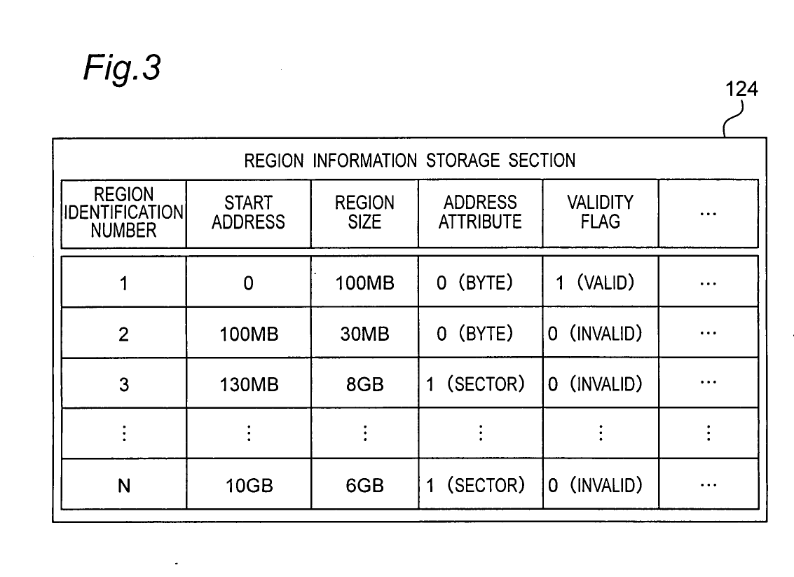

The region information storage section 124 of the recording medium 100 is explained. FIG. 3 shows an example of data structure in the region information storage section 124 of the recording medium 100. The region information storage section 124 stores “region identification number (region ID)” for identifying a recording region in the recording medium 100, “start address” for showing the start address of the recording region, “region size” showing the size of the recording region, “address attribute” showing the address attribute to be used in access to the recording region, and “validity flag” showing whether the recording region is effective recording region or not, and these pieces of information are combined as one set of region information, which is provided corresponding to each recording region in the data storage section 130. That is, the region information is stored as many as the number of recording regions. In the example in FIG. 3, the data storage section 130 is divided into N recording regions, and stores the corresponding quantity of region information. A first recording region (recording region #1) is a region having a size of 100 MB from the beginning address of the data storage section 130. Similarly, a second recording region (recording region #2) is a region having a size of 30 MB, starting from a position 100 MB away from the beginning of the data storage section 130. A third recording region (recording region #3) is a region having a size of 8 GB, starting from a position 130 MB away from the beginning of the data storage section 130, and a N-th region is a region having a size of 6 GB, starting from a position 10 GB away from the beginning of the data storage section 130.

The address attribute is the information showing whether the address specified on access to each recording region should be specified in units of bytes or in units of sectors, in the data storages 130 of the recording medium 100. The address attribute is “0” when specified in units of bytes, and “1” when specified in units of sectors. That is, in the example of FIG. 3, the address in the first recording region is specified in units of bytes, and the address in the third recording region is specified in units of sectors.

The validity flag is the information showing whether each recording region in the recording medium 100 is effective recording region. That is, the validity flag shows which one of the first to N-th recording region is presently accessible from the data processing apparatus 200. In the example of FIG. 3, the first recording region is presently accessible.

Thus, in this embodiment, the address attribute is managed in each region in the region information storage section 124. With reference to this address attribute, the unit of the address specified in the access command can be recognized. That is, in the access command, when specifying a wide address space, the address is specified by data unit of large data size, and otherwise the address can be specified by data unit of small data size. Therefore, without changing the bit width for specifying the address in the format of an access command, a wide address space can be specified. That is, when managing the data in a corresponding file system in each recording region in the recording medium 100, the address can be specified in the format of the same access command, whether in recording region of small capacity or in recording region of large capacity. Therefore, according to the invention, the command format conforming to the conventional file system for managing a narrow address space can be directly applied in a file system for managing a wide address space.

2. Operation of Recording Medium and Data Processing Apparatus

The operation of the recording medium 100 and data processing apparatus 200 having such configuration is explained below.

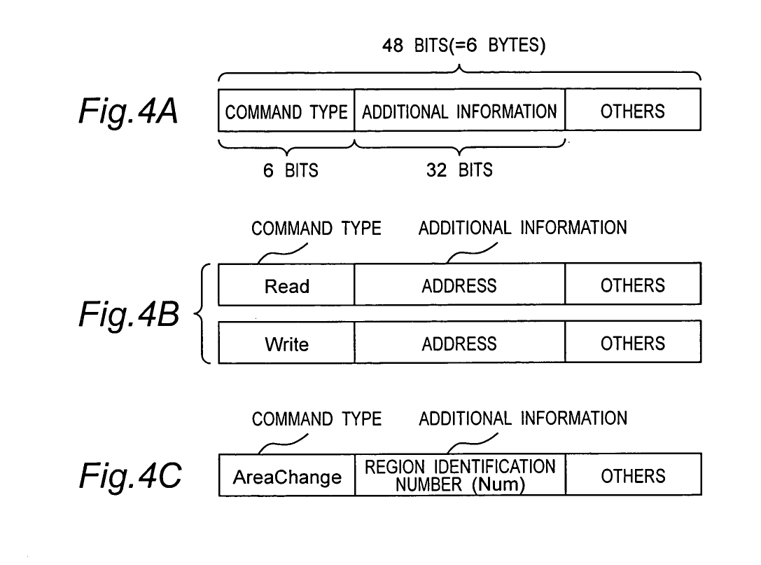

FIG. 4A is a diagram of an example of format of a command transmitted from the data processing apparatus 200 to the recording medium 100. In this example, the command is 48 bits (=6 bytes) length, and includes a region of 6 bits for storing command type, a region of 32 bits for storing additional information corresponding to the type of command, and other region. The other region stores, for example, information for data transfer direction or error correction.

FIG. 4B shows an example of data structure of a Read command for reading out data and a Write command for writing data. The command type stores information of 6 bits meaning “Read” or “Write” showing a read command or write command. Additional information stores value of 32-bit address. Whether the unit of value of address specified in the additional information is byte or sector is determined by the address attribute of the region information storage section 124. The upper limit of the address to be expressed in 32 bits is 4 GB in units of bytes, and 2 TB in units of sectors.

(Initialization Process of Recording Medium)

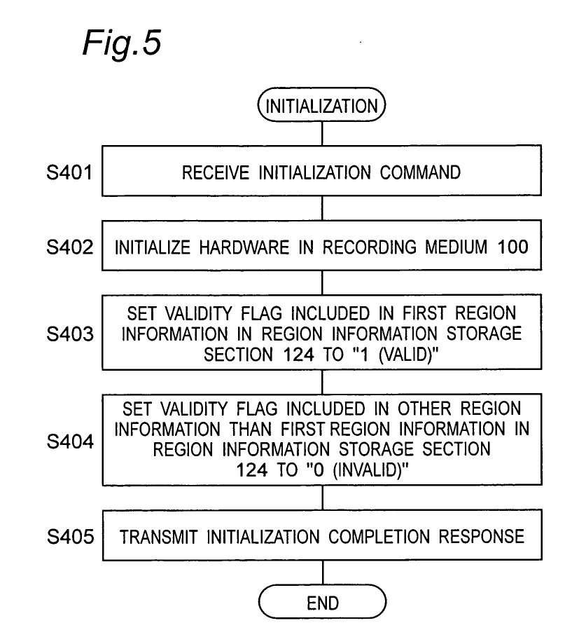

Initialization process of the recording medium 100 in the embodiment is explained. When the recording medium 100 is connected to the data processing apparatus 200, the data processing apparatus 200 transmits an initialization command to the recording medium 100, and initializes the recording medium 100. FIG. 5 is a flowchart of initialization process of the recording medium 100.

In the initialization process, first of all, the host interface 110 of the recording medium 100 receives an initialization command from the data processing apparatus 200 (S401). The controller 120 and data storage section 130 in the recording medium 100 are initialized to be ready for access from outside of the recording medium 100 (S402).

The validity flag included in the first region information in the plural pieces of region information contained in the region information storage section 124 is set to “1” (valid) (S403). All validity flags in region information other than the first region information are set to “0” (invalid) (S404).

Finally, a response showing completion of initialization process is transmitted to the data processing apparatus 200 by way of the host interface 110 of the recording medium 100 (S405).

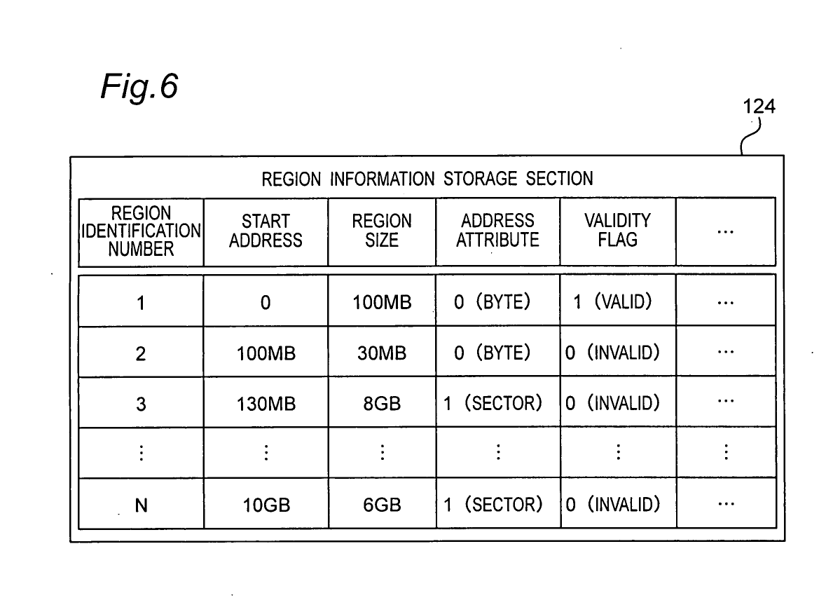

At the moment of completion of the above initialization process, in the region information storage section 124 in the recording medium 100, as shown in FIG. 6, the validity flag is set in “1” (valid) only in the first recording region to cause only this recording region to be accessible from the data processing apparatus 200.

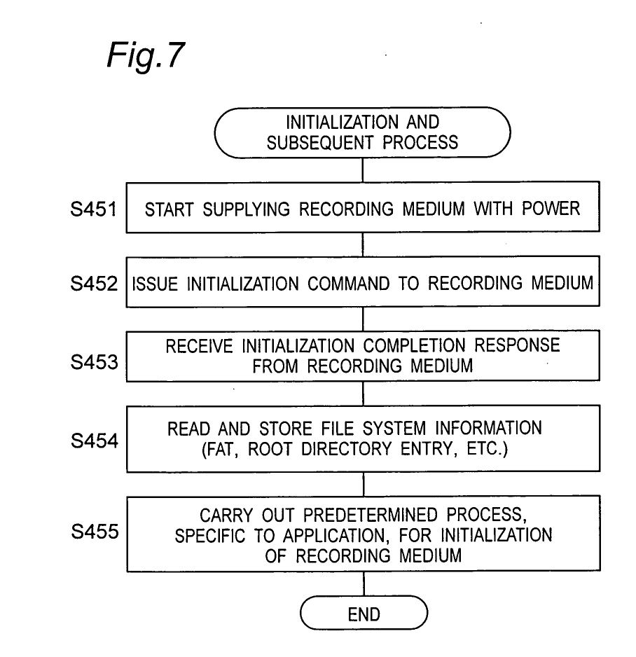

Process of the data processing apparatus 200 for initialization of the recording medium 100 is explained. FIG. 7 is a flowchart of process by the data processing apparatus 200 for initialization of the recording medium 100 and the subsequent process.

When the recording medium 100 is inserted into the recording medium loading section 210 of the data processing apparatus 200, supply of power to the recording medium 100 is started (S451). The driver software 221 of the input and output processing section 220 issues an initialization command to the recording medium 100 (S452). On receiving the initialization command, the recording medium 100 initializes itself as shown in FIG. 5. Then, the data processing apparatus 200 receives an initialization completion response from the recording medium 100 (S453).

Then, the input and output processing section 220 reads out information of the file system relating to the effective recording region of the recording medium 100, and stores the information to a predetermined recording region (not shown) such as RAM (S454). This process is specifically described below using an example of FIG. 6.

In the example of FIG. 6, initialization process sets the effective recording region of the recording medium 100 to the recording region (recording region #1) with region identification number of “1”. The address attribute of the recording region #1 is bytes. Information of the file system of each region of the recording medium is stored in the beginning sector of the region. The input and output processing section 220 specifies the address in units of bytes in order to read out the beginning sector of the recording region #1, and issues a Read command to the recording medium 100. The input and output processing section 220 receives the data of the beginning sector from the recording medium 100, and transfers it to the data processing section 230. The data processing section 230 refers to the data of beginning sector, judges the type of file system (FAT, FAT32, etc.) for managing the recording region #1, acquires file system management information (FAT table, root directory entry, etc.), and stores the information in the specified recording region such as RAM. In these processes, the file system 232 of the data processing section 230 specifies reading range (address, size) in units of sectors, in the driver software 221 of the input and output processing section 220. Since the address attribute of the recording region #1 is “in units of bytes”, the driver software 221 converts the reading range from sectors to bytes (for example, if one sector is 512 bytes, merely multiplying by 512 times), and a Read command is issued to the recording medium 100 in the converted range in units of bytes.

The data processing section 230 runs a predetermined process which is executed by the application program 231 when the recording medium 100 is initialized (S455). For example, when the application program 231 is a program for reproducing music contents, list information about reproducible music contents stored in the recording medium 100 is read out from the recording medium 100, and displayed in display means of the data processing apparatus 200. In such a case, if the application program 231 must read out data from the recording medium 100 after initialization, the application program 231 specifies the reading range in units of bytes in the file system 232. The file system 232 converts the reading range into that in units of sectors, and notifies it to the driver software 221. The driver software 221 converts it to that in units of bytes, and issues a Read command to the recording medium 100.

(Recording Region Changeover Process)

Process for changing over the effective recording region of the recording medium 100 is explained. This recording region changeover process is executed by transmitting the recording region changeover command from the data processing section 200 to the recording medium 100 with specified region identification number of a recording region which is desired to be effective.

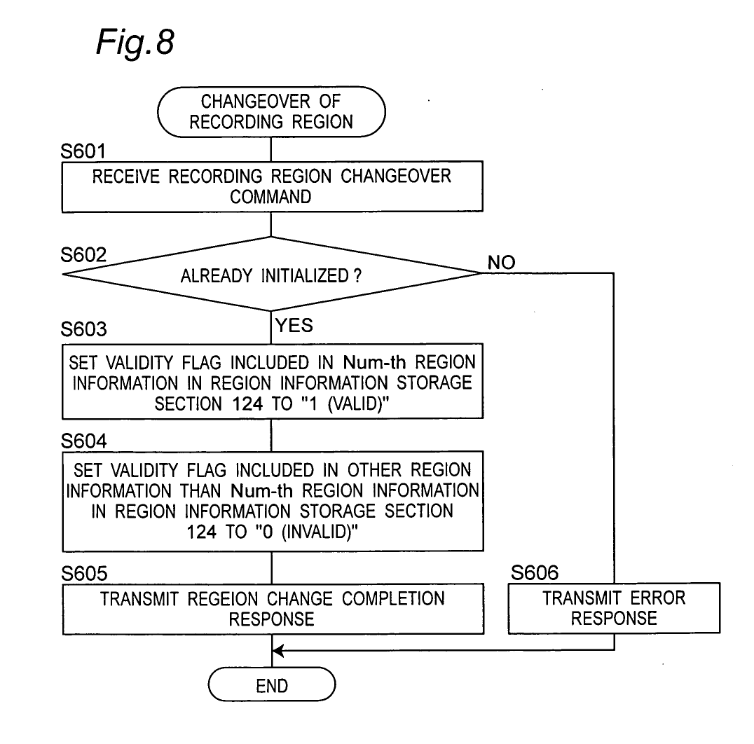

FIG. 8 is a flowchart of recording region changeover process of the recording medium 100. In recording region changeover process, first, the host interface 110 of the recording medium 100 receives the recording region changeover command from the data processing apparatus 200 (S601). The recording region changeover command has a format as shown in FIG. 4C, and the command type stores information of 6 bits of “AreaChange” meaning a recording region changeover command, and the additional information stores the region identification number (Num) of the region desired to be changed over.

The command processing section 121 judges whether the recording medium 100 has been initialized or not (S602). If not initialized, an error response is transmitted to the data processing apparatus 200 by way of the host interface 110 of the recording medium 100, and the process is terminated (S606).

If already initialized, the command processing section 121 refers to the region identification number (Num) specified by the recording region changeover command, and sets the validity flag of the recording region corresponding to the specified region identification number (Num) to “1” (valid), in the region information storage section 124 (S603).

At the same time, the validity flags of all other recording regions than the recording region of which validity flag was set to “1” (valid), are set to “0” (invalid) (S604).

Finally, a completion response showing completion of recording region changeover process is transmitted to the data processing apparatus 200 by way of the host interface 110 of the recording medium 100 (S605).

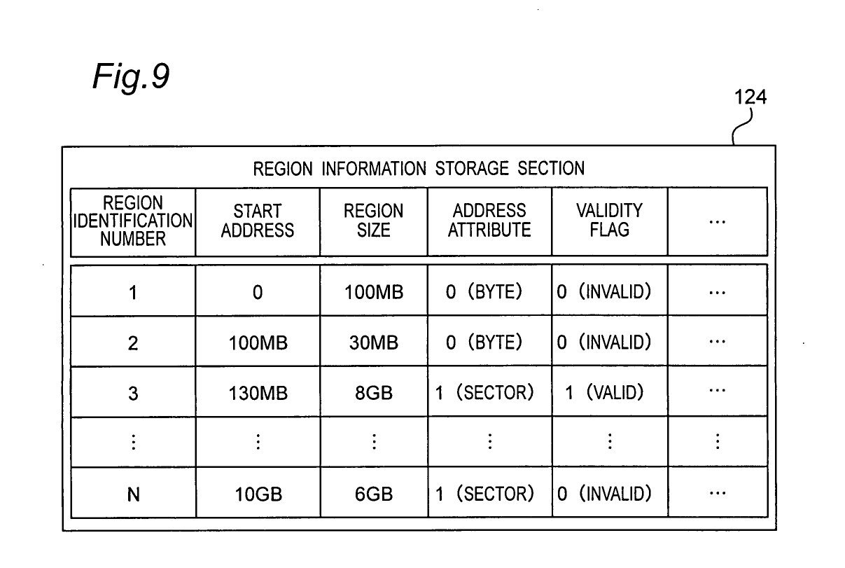

After this recording region changeover process, an example of the region information storage section 124 in the recording medium 100 is shown in FIG. 9. The diagram shows the example which the effective recording region is changed over to the region of which region identification number is “3” (recording region #3). The validity flag is set valid only in the third region, and the data processing apparatus 200 can access only the third recording region.

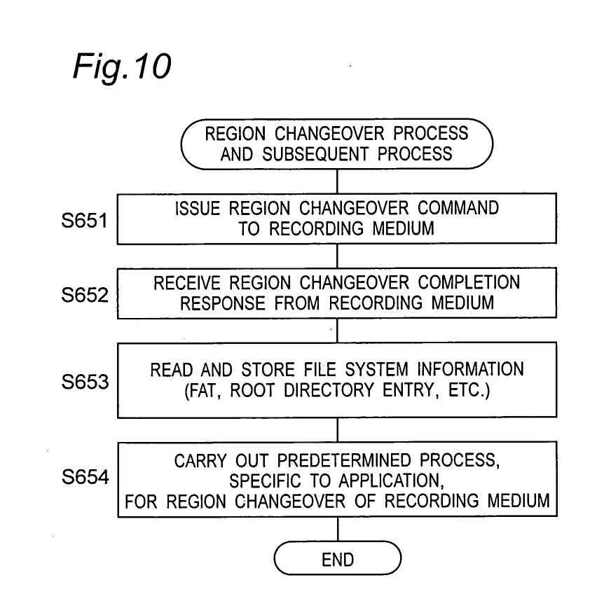

Processing of the data processing apparatus 200 in the case of the region changeover process on the recording medium 100 is explained. FIG. 10 is a flowchart of the region changeover process of the recording medium 100 and subsequent processes in the data processing apparatus 200.

To change over recording regions of the recording medium 100, the driver software 221 of the input and output processing section 220 issues a region changeover command to the recording medium 100 (S651). Receiving this region changeover command, the recording medium 100 changes over the regions as shown in FIG. 8. Later, the data processing apparatus 200 receives a completion response of region changeover process from the recording medium 100 (S652).

Afterwards, same as in the case of initialization process, information of file system about effective recording region of the recording medium 100 is read out and stored (S653), and predetermined process after region setting of the recording medium is executed by application program 231 (S654). Specific procedures of steps S653 and S654 are same as those of steps S454, S455.

Other example of region changeover process of the recording medium is shown. In this example, when the data processing apparatus 200 transmits a recording region changeover command, the address attribute can be also specified.

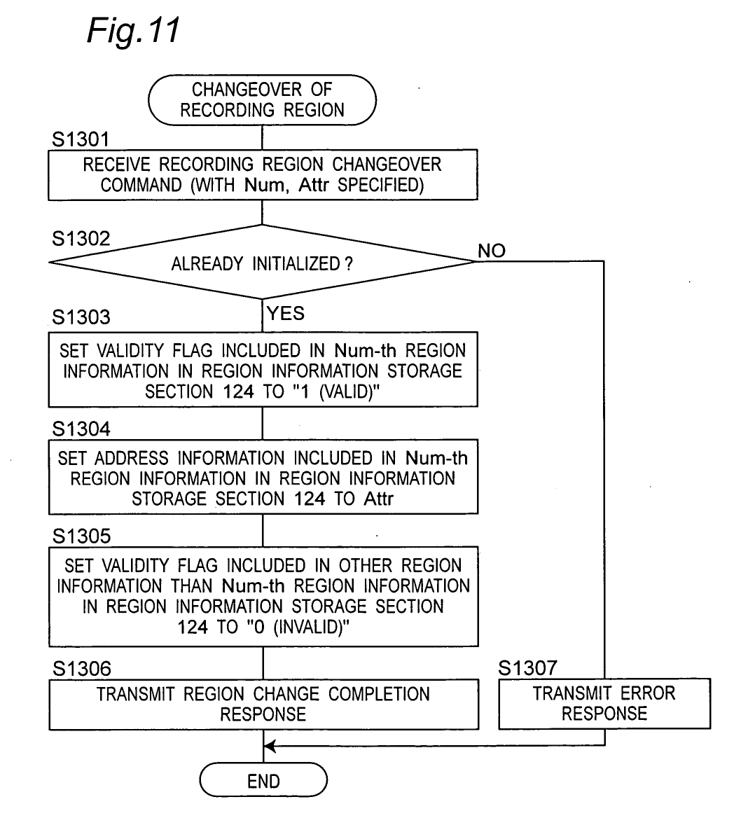

FIG. 11 is a flowchart of other example of recording region changeover process of the recording medium 100.

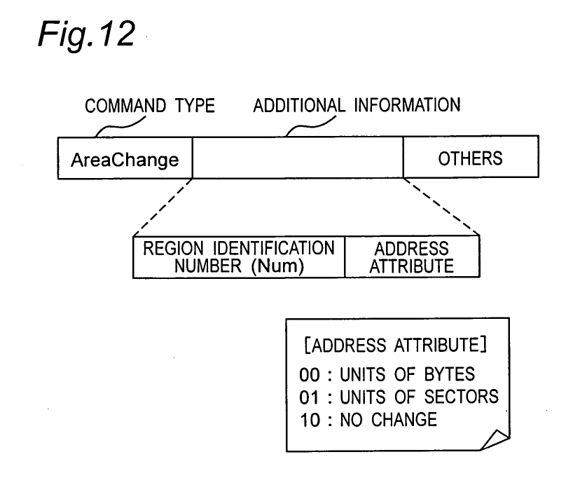

First, the host interface 110 of the recording medium 100 receives a recording region changeover command from the data processing apparatus 200 (S1301). In this example, the recording region changeover command has a format as shown in FIG. 12. The command type stores information of 6 bits of “AreaChange” meaning a region changeover command, and the additional information stores the region identification number (Num) of the recording region desired to be changed over and address attribute (Attr) desired to be set in this recording region. In the example in FIG. 12, the address attribute is extended to value of 2 bits, and “00” is specified in units of bytes, “01” is set in units of sectors, and “10” is specified when not changing the present setting.

The command processing section 121 judges whether the recording medium 100 has been initialized or not (S1302). If not initialized, an error response is transmitted to the data processing apparatus 200 by way of the host interface 110 of the recording medium 100, and the process is terminated (S1307).

If already initialized, referring to the region identification number (Num) specified by the recording region changeover command, the validity flag of the corresponding recording region in the region information storage section 124 is set to “1” (valid) (S1303).

At the same time, the address attribute corresponding to the recording region of which validity flag is set to “1” (valid) is set to the value of “Attr” specified by the command. However, if the value of specified Attr is “10” (no change), the address attribute is not changed (S1304).

Next, the validity flags of all other recording regions other than the recording region of which validity flag was set to “1” (valid) at S1303, are set to “0” (invalid) (S1305).

Finally, a response showing completion of recording region changeover process is transmitted to the data processing apparatus 200 by way of the host interface 110 of the recording medium 100 (S1306).

According to this recording region changeover process, at the timing of instructing recording region changeover of the recording medium 100 by the data processing apparatus 200, the address attribute of the recording region desired to be changed over can be set to a desired value.

(Access Process on Recording Medium)

Access process on the recording medium 100 is explained. Data reading and/or writing on the recording medium 100 is executed by transmitting data reading and/or writing command, that is, Read/Write command to the recording medium 100.

Data reading process from the recording medium 100 is explained.

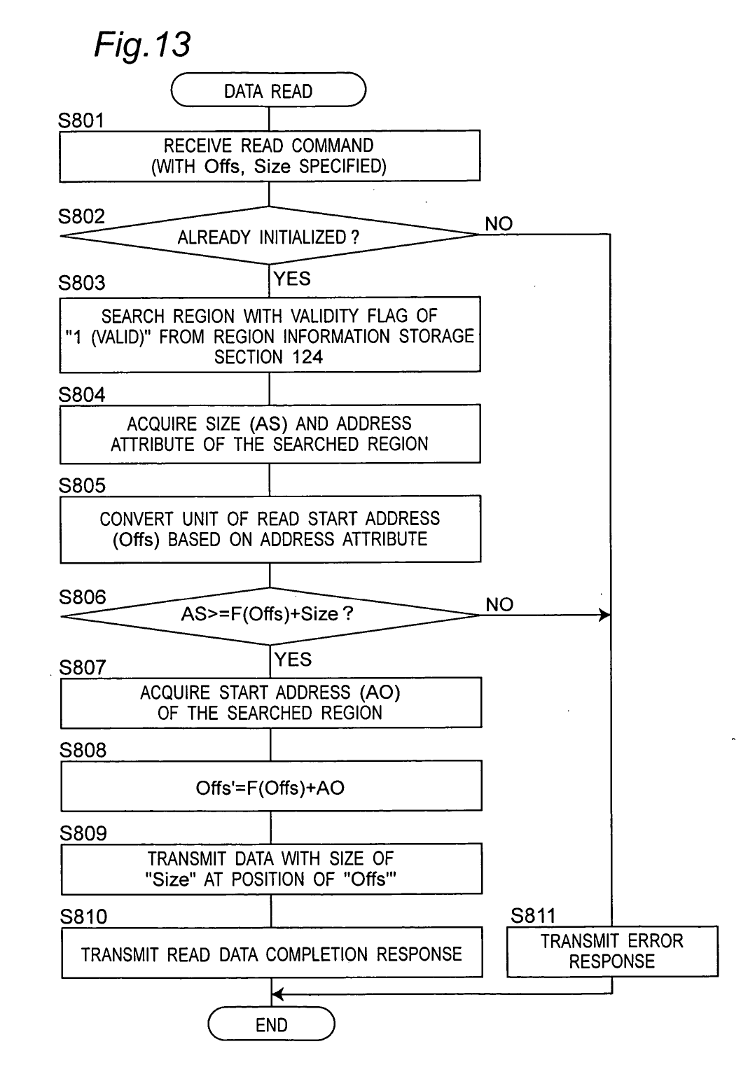

FIG. 13 is a flowchart of data reading process in the recording medium 100. In data reading process, first, the host interface 110 of the recording medium 100 receives a Read command from the data processing apparatus 200 (S801). The Read command has a format as shown in FIG. 4B and address (Offs) for starting reading is specified. Further, the size (Size) of data to be read out is specified. If the size is a fixed value, however, specification of size can be omitted.

The command processing section 121 judges whether the recording medium 100 has been initialized or not (S802). If not initialized, an error response is transmitted to the data processing apparatus 200 by way of the host interface 110 of the recording medium 100, and the process is terminated (S810).

If already initialized, the access region judging section 122 refers to the region information of the region information storage section 124, and searches for region of which validity flag is “1” (valid) (S803). The address determining region 123 acquires the region size AS and address attribute of the searched region (S804).

On the basis of the acquired address attribute, it is judged whether the unit of reading start address (Offs) specified by a command is byte or sector, and it is changed to unit of byte in the case of sector (S805). The changed is F (Offs).

Adding Size to F (Offs), the sum is compare with AS, and it is checked if all reading regions are included in accessible regions or not (S806).

If AS is smaller than {F (Offs)+Size}, reading regions are larger than accessible regions, and an error response is transmitted to the data processing apparatus 200 by way of the host interface 110 of the recording medium 100, and the process is terminated (S811).

If AS is larger than {F (Offs)+Size}, start address AO of searched region is acquired (S807)

To determine the reading start position of recording region, AO is added to F (Offs), and Offs′ is calculated (S808).

The recording region access section 125 reads out data of the portion of Size from the position of Offs′, and transmits the read data to the data processing apparatus 200 by way of the host interface 110 of the recording medium 100 (S809).

Finally, a completion response showing completion of data reading process is transmitted to the data processing apparatus 200 by way of the host interface 110 of the recording medium 100 (S810).

Thus, in the recording medium 100, information on presently effective recording region (effective recording region) is managed, and the access position specified from the data processing apparatus 200 is converted into physical address in the presently effective recording region, and it is allowed to access a specific recording region out of the plural divided recording regions. The address given from the data processing apparatus 200 is interpreted in the address attribute (in units of bytes or in units of sectors) corresponding to the recording region to be accessed in the recording medium 100.

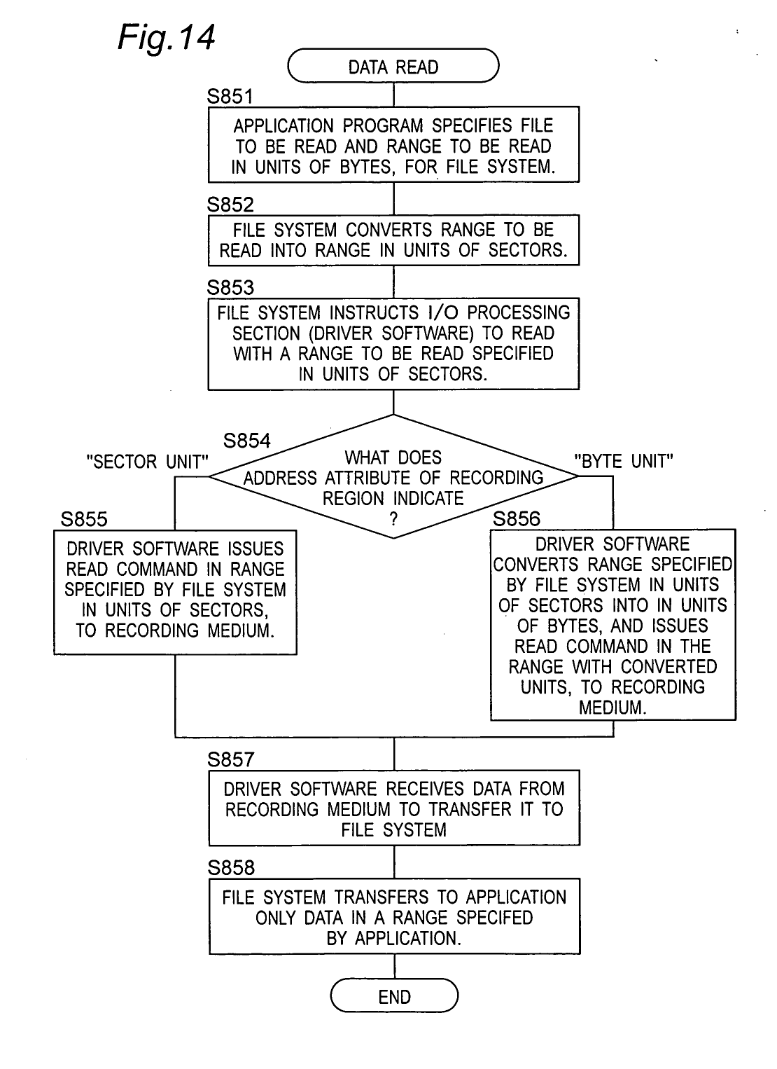

When reading out data from the recording medium 100, the process in the data processing apparatus 200 is explained. FIG. 14 is a flowchart of data reading process in the data processing apparatus 200 to read out data in the recording medium 100.

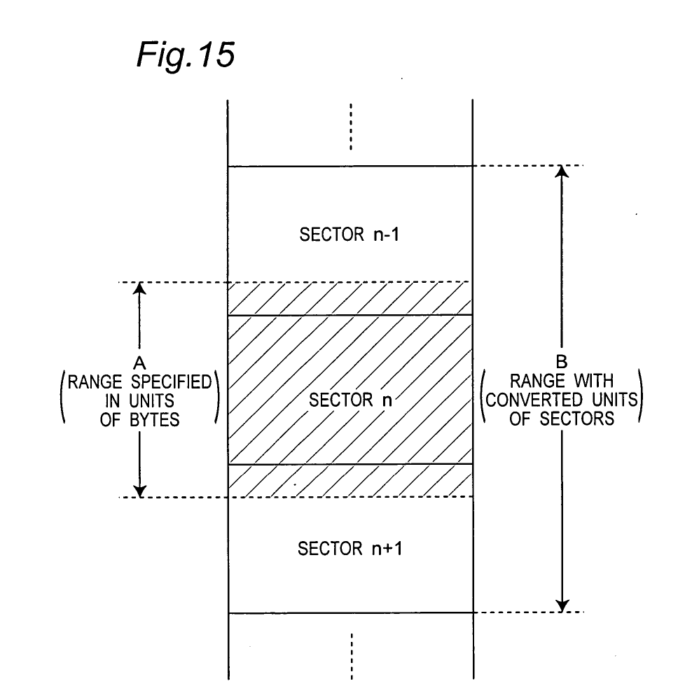

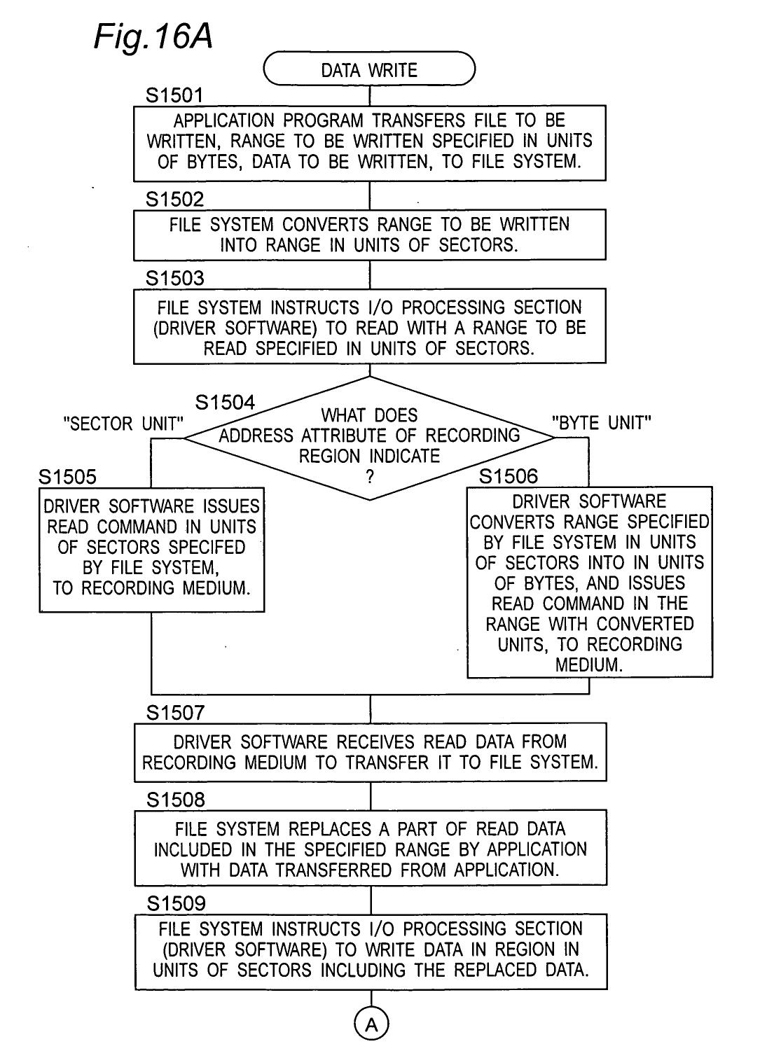

To the file system 232, the application program 231 specifies the file to be read out and the range to be read out in units of bytes (S851). The file system 232 converts the range to be read specified in units of bytes into a range in units of sectors (S852). At this time, as shown in FIG. 15, when the boundary of range specified in units of bytes does not coincide with the boundary of a sector, range (B) in units of sectors after conversion must be determined so that range (B) in units of sectors after conversion includes region (A) in units of bytes before conversion.

The file system 232 instructs the input and output processing section 220 (driver software 221) to read out data in reading range specified in units of sectors after conversion (S853).

The driver software 221 judges whether the address attribute of the present effective recording region of the recording medium 100 is “in units of sectors” or “in units of bytes” (S854).

If the address attribute is in units of sectors, the driver software 221 issues a Read command to the recording medium 100 in reading range in units of sectors specified by the file system 232 (S855).

If the address attribute is “in units of bytes”, the driver software 221 converts the range in units of sectors specified by the file system 232 to a range of bytes, and issues a Read command to the recording medium 100 in this range in units of bytes (S856).

The driver software 221 receives data from the recording medium 100 corresponding to the Read command, and transfers the data file to the file system 232 (S857).

The file system 232 transfers only the data in the range specified by the application program 231, out of the received data, to the application program 231 (S858). That is, the data being read out from the recording medium 100 corresponds to a wide address range (B) specified in units of sectors as shown in FIG. 15, but the data actually requested by the application program 231 corresponds to narrow range (A) specified in units of bytes. Accordingly, the file system 232 transmits only the actually requested portion (A) out of the data being read out from the recording medium to the application program 231.

Process of the data processing apparatus 200 when writing data into the recording medium 100 is explained.

The data processing section 230 (application program 231) transmits the file to be written, range to be written and specified in units of bytes, and data to be written to the file system 232 (S1501). The file system 232 converts the range to be written into range in units of sectors (S1502). At this time, as shown in FIG. 15, when the boundary of range specified in units of bytes does not coincide with the boundary of a sector, range (B) after conversion is set so that range (B) after conversion may include region (A) specified in units of bytes.

The file system 232 instructs the input and output processing section 220 (driver software 221) to read out data in the reading range specified in units of sectors after conversion (S1503). The driver software 221 judges the address attribute of effective recording region of the recording medium 100 (S1504).

If the address attribute of effective recording region is “in units of sectors”, the driver software 221 issues a Read command to the recording medium 100 in a range in units of sectors specified by the file system 232 (S1505).

If the address attribute of effective recording region is “in units of bytes”, the driver software 221 converts the range “in units of sectors” specified by the file system 232 to range “in units of bytes”, and issues a Read command to the recording medium 100 in the range after conversion (S1506).

The driver software 221 receives data being read out from the recording medium 100, and sends the data to the file system 232 (S1507).

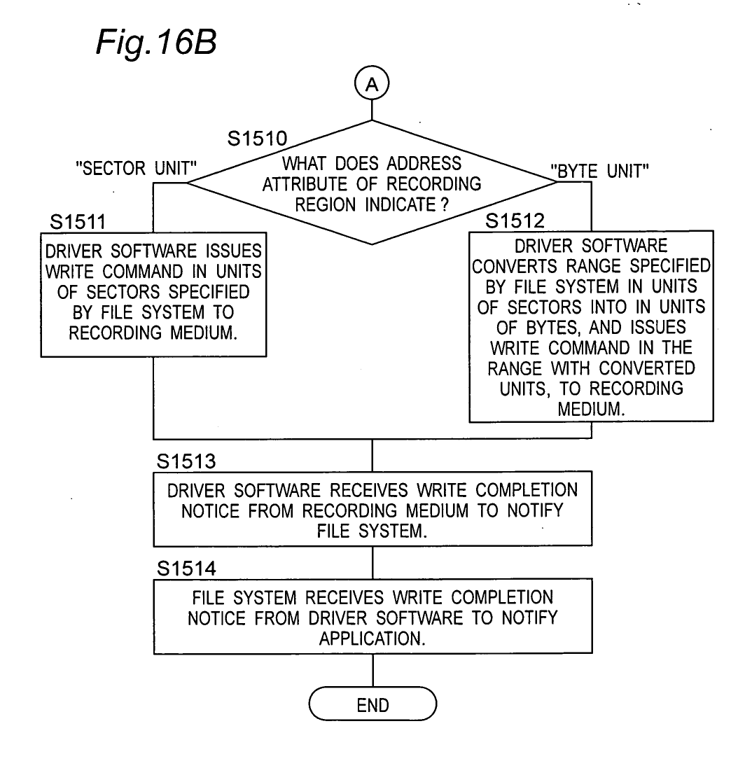

The file system 232 replaces the data in a range specified by application program 231 in the data being read out from the recording medium 100 with the data sent from the application program 231 (S1508). That is, as shown in FIG. 17, of the data being read out from the recording medium 100, the portion of the range (D) actually specified by the application program 231 is replaced by the data specified by the application program 231.

Consequently, the file system 232 instructs the input and output processing section 220 (driver software 221) to write data in a range in units of sectors including the replaced data (S1509).

The driver software 221 judges the address attribute of effective recording region of the recording medium 100 (S1510).

If the address attribute of effective recording region is “in units of sectors”, the driver software 221 issues a Write command to the recording medium 100 so as to write data received from the file system 232 in the range in units of sectors specified by the file system 232 (S1511).

If the address attribute of the effective recording region is “in units of bytes”, the driver software 221 converts the range in units of sectors specified by the file system 232 to range in units of bytes, and issues a Write command to the recording medium 100 so as to write the data received from the file system 232 in the range after conversion (S1512).

The driver software 221 receives a write completion notice from the recording medium 100 to notify the file system 232 (S1513). The file system 232 receives a write completion notice from the driver software 221, and further notices it to the application program 231 (S1514).

In the recording medium 100, when receiving a Write command from the data processing apparatus 200, the unit of write address specified by the Write command is recognized by referring to the address attribute in the region information storage section 124, and by converting the specified address unit appropriately, the destination of writing can be specified, and writing action can be executed.

(Changing Procedure of Region Size of Recording Region)

This is to explain the procedure of changing (setting) the region size of each recording region of the data storage section 130 in the recording medium 100. This region size setting process is executed by transmitting a region size setting command specifying the region identification number of the recording region desired to be set, the start address, and size of the region, from the data processing apparatus 200 to the recording medium 100.

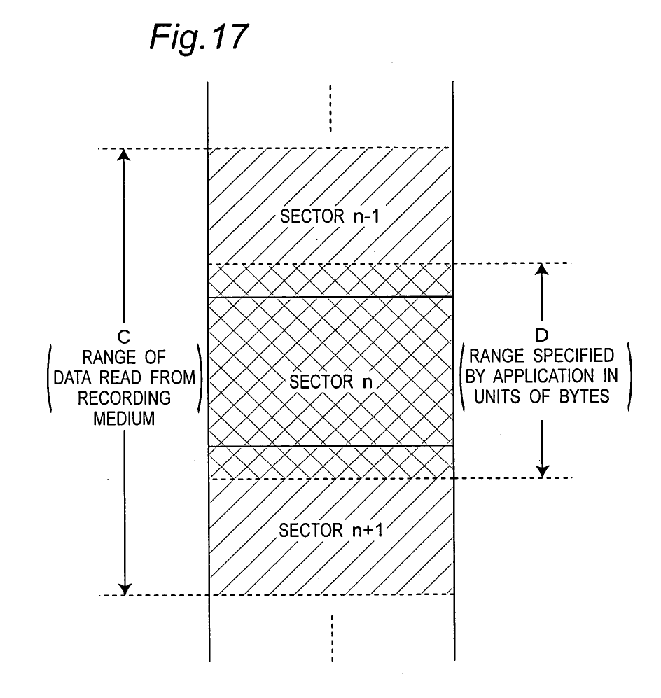

FIG. 18 is a flowchart showing the flow of region size setting process in the recording medium 100.

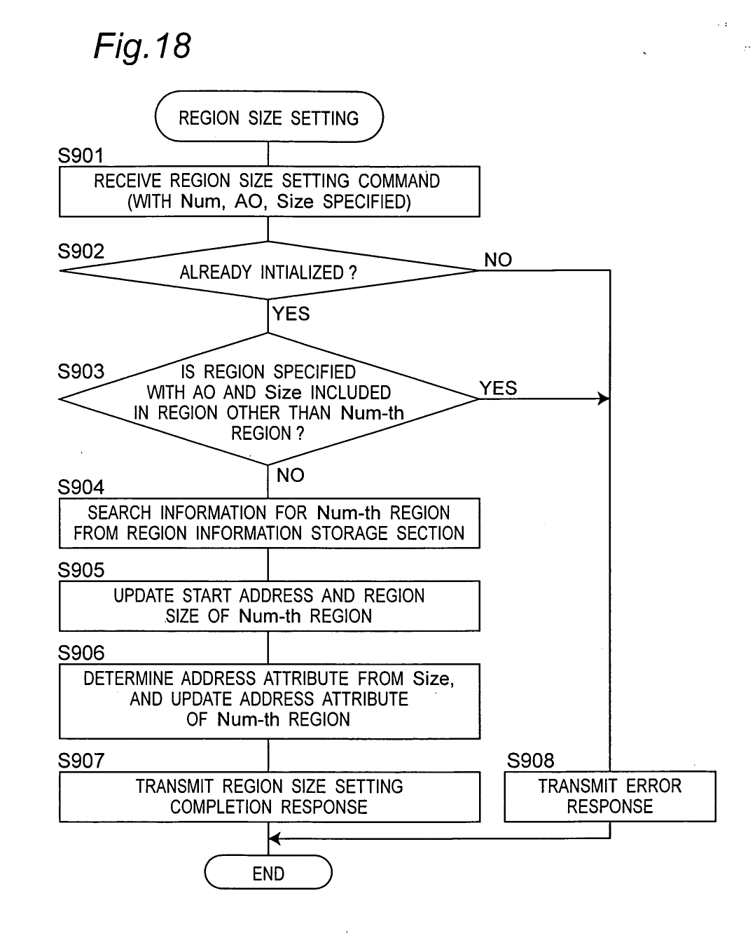

First, the host interface 110 of the recording medium 100 receives a region size setting command from the data processing apparatus 200 (S901). In the region size setting command, the region identification number (Num) of the region desired to set region size, start address (AO), and region size (Size) to be set are specified. FIG. 19 shows an example of command for setting these pieces of information. In the example in FIG. 19, the region identification number (Num) is specified by AreaChange command shown in FIG. 19(a), the start address (AO) is specified by a SetAO command shown in FIG. 19(b), the region size (Size) is specified by a SetSize command shown in FIG. 19(c), and finally start of region size setting is instructed by a ChangeAreaSize command shown in FIG. 19(d).

Consequently, the command processing section 121 judges whether the recording medium 100 has been initialized or not (S902). If not initialized, an error response is transmitted to the data processing apparatus 200 by way of the host interface 110 of the recording medium 100, and the process is terminated (S908).

If already initialized, the command processing section 121 checks if the recording regions other than the Num-th recording region include any recording region in which the start address is AO and size is Size, or not (S903).

If such recording region is included, the Num-th recording region after region size setting overlaps with an existing recording region, which is inconvenient, and an error response is transmitted to the data processing apparatus 200 by way of the host interface 110 of the recording medium 100, and the process is terminated (S908).

If such recording region is not included, the region information about the Num-th recording region is searched from the region information storage section 124 (S904).

The start address and region size of searched region information about the Num-th recording region are changed to AO and Size specified by a command respectively (S905).

The value of address attribute is determined from Size specified by a received command, and the address attribute of region information about the Num-th region is updated (S906). At this time, if the address attribute is determined as “0” (in units of bytes), for example, if Size is smaller than predetermined value, or determined as “1” (in units of sectors) if Size is more than predetermined value.

Finally, a response showing completion of region size setting process is transmitted to the data processing apparatus 200 by way of the host interface 110 of the recording medium 100 (S907).

In region size setting process, if the recording region after setting does not overlap with other recording region, the region size can be set in this procedure. The address attribute is determined automatically depending on the new region size.

(Deletion Process of Recording Region)

When combining two recording regions into one recording region, for example, the recording region after setting overlaps with other recording region, and the two recording regions must be first deleted, and then the region size should be set. This deletion process of recording region is explained below.

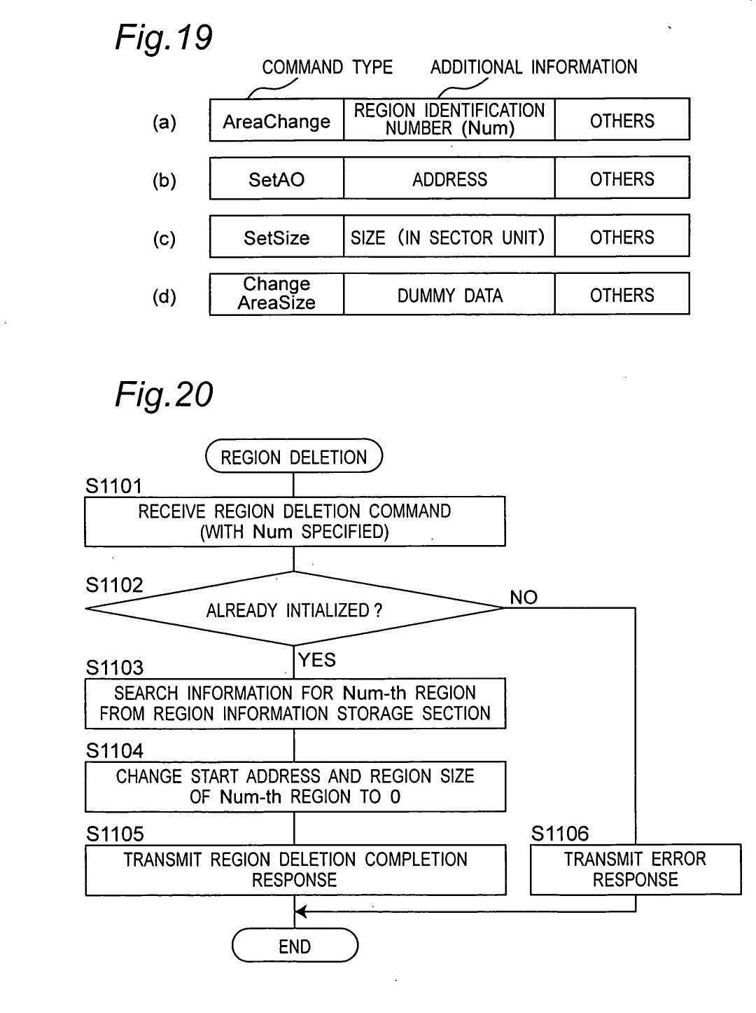

FIG. 20 is a flowchart of region deletion process in the recording medium 100.

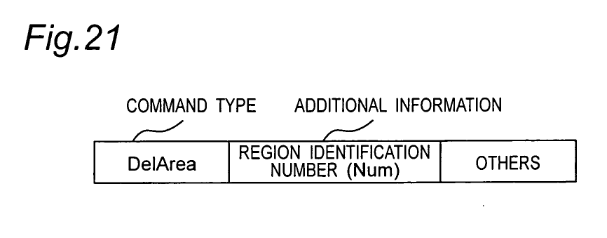

In the region deletion process, first, the host interface 110 of the recording medium 100 receives a region deletion command from the data processing apparatus 200 (S1101). The region deletion command is composed as shown in FIG. 21, in which the control type stores information of 6 bits meaning “DelArea” showing region deletion, and the additional information stores the region identification number (Num) of the region to be deleted.

The command processing section 121 judges whether the recording medium 100 has been initialized or not (S1102). If not initialized, an error response is transmitted to the data processing apparatus 200 by way of the host interface 110 of the recording medium 100, and the process is terminated (S1106).

If already initialized, region information about the Num-th recording region is searched from the region information storage section 124 (S1103).

The start address and region size of searched region information about the Num-th recording region are both changed to 0 (S1104).

Finally, a region deletion completion response is transmitted to the data processing apparatus 200 by way of the host interface 110 of the recording medium 100 (S1105).

Thus, according to the invention, by issuing a recording region changeover command before accessing the data in the recording medium 100, it is possible to change over to a desired recording region. Therefore, when the data storage section 130 in the recording medium 100 is divided into plural sections, and independent file systems are built up in individual recording regions, the data processing apparatus 200 can select a recording region having a file system that can be interpreted by itself, and access it. Depending on the size of the selected recording region, the address attribute (in units of bytes or in units of sectors) is changed automatically, and hence it is not necessary to set the address attribute newly before reading or writing.

In the embodiment, the command format shown in FIG. 4A is explained, but it is only an example. The bit length of a command, or the type of a field may be changed as desired. For example, when the bit length is extended, the command for changing the region size shown in FIG. 19 can be transmitted as one command without dividing into four.

In the embodiment, the address attribute has two choices, in units of bytes or in units of sectors, but it may be set in other unit (for example, in units of clusters).

In the embodiment, in explanation of data reading process, it is an error when attempted to access over an effective region, but it may be also specified to read only readable data.

As for the specifying method of reading size (Size), if necessary to change over the setting (in units of bytes or in units of sectors) depending on the selected recording region, a new field of size attribute may be newly prepared in the region information storage region 124, and it may be processed same as in the address specifying method explained in the embodiment. When the address specifying method and size specifying method are synchronized, the address attribute may be used commonly as the size attribute.

In explanation of data reading process, the reading size (Size) is first set by the data processing apparatus 200, but it may not be set beforehand. For example, only the reading start address (Offs) is set, and the recording medium 100 reads out data from the data processing apparatus 200, and may continue to read out data and transmit the data to the data processing apparatus 200 until a stop command (Stop command) is transmitted.

In the embodiment, the validity flag is set in the first recording region when initializing, but by using other special command, the recording region to be set first in initialization process can be specified by the data processing apparatus 200.

Or it may be determined by referring to the field in the region information storage region 124 storing physical specification such as address attribute. For example, by searching sequentially from the first recording region, the validity flag may be set in the first recording region of which address attribute is “0” (in units of bytes).

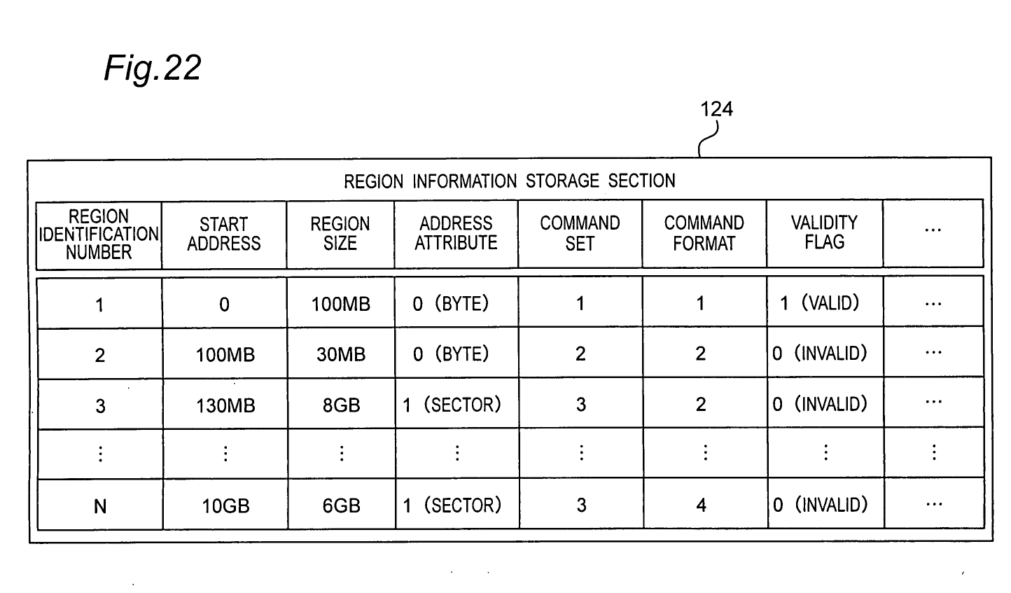

In the embodiment, address attribute is described as information of physical specification of each recording region, but other information may be stored in the region information storage region 124, and it may be used together and linked with region changeover. For example, as shown in FIG. 22, the region information storage section 124 may store the command set number in addition to the address attribute. At this time, synchronously with changeover process of recording region, the command set can be changed over automatically. Or as shown in FIG. 22, a command format number may be stored in the region storage region 124. At this time, synchronously with changeover process of recording region, the command format can be changed over automatically.

In the embodiment, the address attribute is automatically determined depending on the size of recording region, but by using other special command, the data processing apparatus 200 may include means for changing to a desired value.

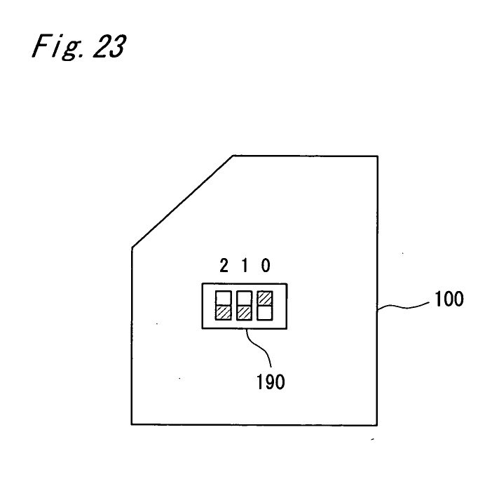

The recording medium 100 may be also provided with a physical switch, and the effective recording region of the recording medium 100 can be set by this switch. For example, as shown in FIG. 23, DIP switch may be provided in the recording medium 100. The recording medium 100 in FIG. 23 has DIP switch 190 of 3 bits, and eight recording regions can be changed over by properly setting each bit.

The invention has been explained about a specific embodiment, but it may be easily changed, modified, or applied for those skilled in the art. The invention is hence not limited to the specific embodiment, but is limited only by the scope of the accompanying claims.

### INDUSTRIAL APPLICABILITY

The invention can be applied in an information recording medium having plural recording regions differing in size, and is very useful, for example, in a recording medium having each recording region managed by different file systems and also having recording regions of a wide address space.

1. A recording medium to/from which data can be written/read by a data processing apparatus, comprising:
a host interface operable to communicate with the data processing apparatus;
a data storage section having plural recording regions for storing data; and
a region information storage section for storing information about each recording region of the data storage section,
wherein the region information storage section stores information about address attribute of each recording region of the data storage section.

2. The recording medium according to claim 1, wherein the address attribute is a unit of address specified from the data processing apparatus for access to the recording region of the recording medium.

3. The recording medium according to claim 2, wherein the unit of address is sector or byte.

4. The recording medium according to claim 2, further comprising a controller operable to receive a command for instructing writing or reading of data from the data processing apparatus by way of the host interface, and when the received command specifies an address indicating the access region, judge unit of the address specified by the received command, on the basis of the address attribute stored in the region information storage section.

5. The recording medium according to claim 1, wherein data stored in each recording region is managed by the file system corresponding to each recording region.

6. The recording medium according to claim 1, wherein the region information storage section further stores information about type of command set of the command received in the host interface.

7. The recording medium according to claim 1, wherein the region information storage section further stores information about type of format of the command received in the host interface.

8. The recording medium according to claim 1, further comprising a controller operable to receive, from the data processing apparatus by way of the host interface, a command for setting an accessible recording region in the data storage section from the data processing apparatus, set an accessible region in the region information storage section according to the received command when the received command specifies the address attribute of the recording region set to be accessible, and change the address attribute of the accessible region set.

9. The recording medium according to claim 1, further comprising a controller operable to, when receiving a command for changing size of recording region in the data storage section through the host interface from the data processing apparatus, change size of recording region according to the received command, determine the address attribute of the changed recording region according to the changed size of the recording region, and update the region information storage section using the determined address attribute.

10. A control method of a recording medium having a data storage region for storing data, the data storage region accessible from outside for writing and reading data, the control method comprising:
dividing the data storage region of the recording medium into plural recording regions; and
storing region information which is information about each divided recording region to a predetermined region in the recording medium,
wherein the region information includes information about address attribute of each recording region.

11. The control method according to claim 10, wherein the address attribute is a unit of address specified for access to the recording region of the recording medium.

12. The control method according to claim 10, wherein the unit of address is sector or byte.

13. The control method according to claim 11, further comprising:
receiving a command for instructing writing or reading of data, with an address showing access range specified in the command; and
judging unit of the address specified by the received command, on the basis of the stored address attribute, to specify the access range.

14. The control method according to claim 10, wherein data stored in each recording region is managed by the file system corresponding to each recording region.

15. The control method according to claim 10, wherein the region information further stores information about type of command set of the received command.

16. The control method according to claim 10, wherein the region information further stores information about type of format of the received command.

17. The control method according to claim 10, wherein the region information includes information of a recording region accessible from outside, and the control method further comprises:
receiving a command for setting a recording region accessible from outside, the command specifying the address attribute of the accessible recording region, and
in the region information, setting the accessible recording region and changing the information about the address attribute of the accessible recording region set, according to the received command.

18. The control method according to claim 10, wherein the region information further includes size of each recording region, and the control method further comprises:
receiving a command for changing size of recording region of the recording medium;
changing the size of recording region according to the received command; and
determining the address attribute of the changed recording region according to the changed size of recording region, and updating the region information using the determined address attribute.
